(19) United States
(12) Patent Application Publication
(10) Pub. No.: US 2018/0245475 A1
(43) Pub. Date: Aug. 30, 2018

(54) GAS TURBINE BLADE OR COMPRESSOR BLADE HAVING ANTI-FRETTING COATING IN THE BLADE ROOT REGION AND ROTOR

(71) Applicant: SIEMENS AKTIENGESELLSCHAFT, MÜNCHEN (DE)

(72) Inventors: TONI KREIBICH, BERLIN (DE); RONALD WALLSTABE, BERLIN (DE)

(21) Appl. No.: 15/752,895

(22) PCT Filed: Aug. 19, 2015
(86) PCT No.: PCT/EP2015/069013

§ 371 Date: Feb. 15, 2018

(51) Int. Cl. F01D 5/30; F04D 29/34

(52) U.S. Cl. CPC F01D 5/3092; F05D 2300/611; F05D 2220/32; F04D 29/34

(57) ABSTRACT

The use of a polymer coating in the carrying flank region minimizes damages. Moreover, a long-term separating effect between the components, e.g. rotor blade and rotor disk, is ensured. According to the embodiments, the rotor disk groove can alternatively also be coated in whole or in part.

### CROSS-REFERENCE TO RELATED APPLICATIONS

This application claims priority to PCT Application No. PCT/EP2015/069013, having a filing date of Aug. 19, 2015, the entire contents of which are hereby incorporated by reference.

### FIELD OF TECHNOLOGY

The following relates to a gas turbine blade or a compressor blade having a polymer coating in the securing region, and to a rotor.

### BACKGROUND

In general, a rotor blade is connected to a rotor disk by a corresponding slot in a form-fitting manner in the slot region or securing region. The rotor blades are installed and removed in the axial slot direction.

During operation, rotor blades are loaded both by the centrifugal force, as a function of rotor blade weight and rotational speed, and by the aerodynamic forces. These forces must be absorbed in the contact region between the blade root and the rotor disk slot, the so-called pressure face region.

Over the course of the life of the compressor, the following damage mechanisms can occur in the region of the pressure faces of the compressor rotor blade roots and the rotor disk slots: fretting and/or fretting fatigue, and local adhesion/cold welding and, as a consequence, transfer of material with subsequent scoring/galling on removal of the blade. Removal of rotor blades, which is necessary for maintenance purposes, can be made more difficult by the latter-mentioned damage mechanisms.

These damage mechanisms can arise fundamentally in axial-flow compressors, in the contact region between the rotor blade and the rotor disk slot, in which the rotor blades are connected in a form-fitting manner to the rotor disk. Depending on the severity, these results make it necessary to repair or replace the damaged components, which is associated with additional costs.

The coatings generally used hitherto for reducing or preventing fretting results are metallic, e.g. CuNiIn or NiTiCr. The methods used for this are for example cold gas spraying, flame spraying and plasma spraying such as HVOF (high velocity oxygen fuel spraying) or APS.

The operating principle of these coating systems with respect to anti-fretting relies in essence on their deformability (low shear strength). Thus, the input of energy due to relative movement is reduced by a low coefficient of friction between the rotor blade and rotor disk slot components, and possible fretting and thus also fretting fatigue is reduced.

A drawback of the coatings used hitherto is that the components of the coating are metallic, as is the material of the rotor disk. This means that similar materials are in contact with one another, which promotes adhesion/cold welding. As a consequence, problems can arise during installation/removal in spite of the CuNiIn coating in the contact region. Furthermore, damage to the coatings used hitherto can be repaired only with great difficulty.

The embodiments therefore have the object of solving the aforementioned problems.

### SUMMARY

An aspect relates to a turbine blade or compressor blade.

### BRIEF DESCRIPTION

Some of the embodiments will be described in detail, with references to the following figures, wherein like designations denote like members, wherein:

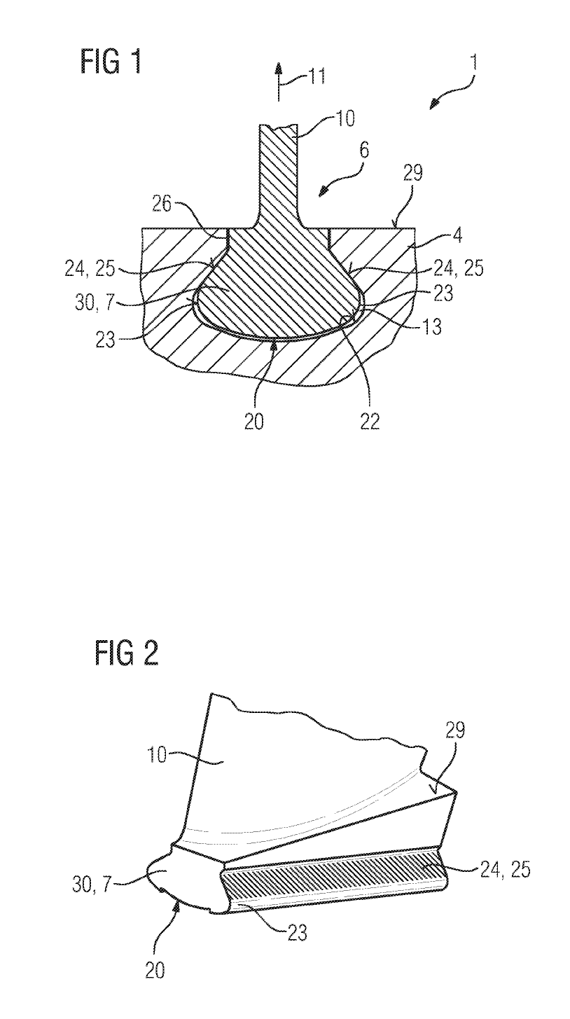

FIG. 1 is a view of an installed turbine blade or compressor blade; and

FIG. 2 is a three-dimensional illustration of a turbine blade or compressor blade.

### DETAILED DESCRIPTION

The figures and the description represent only exemplary embodiments of the invention.

FIG. 1 shows part of a rotor 1 which has a rotor disk 4 comprising, in the rotor disk 4, a slot region 13 in which there is arranged a turbine blade 6 or a compressor blade 6. A blade root 7 of the blade 6 is inserted into the slot region 13.

A blade airfoil 10 of the blade 6 projects out beyond an outer surface 29 of the rotor disk 4.

As seen in the longitudinal direction 11 of the blade 6, the blade root 7 has a lower region 20 which has a slight convex curvature.

Adjoining either side of the lower, relatively flat region 20 is a region 23 having greater, also convex, curvature.

Adjoining the more curved region 23 is a pressure face region 24 that comes into contact with the rotor disk 4.

The pressure face region 24 is planar.

Optionally adjoining the pressure face region 24 is a further end region 26 which may have various designs and in this case runs perpendicular to the surface 29 of the rotor disk 4.

The pressure face region 24, most particularly the entire blade root 20, 23, 24, 26, in particular excepting the end face 30 of the blade root 7, in particular of compressor rotor blades, is provided with a polymer coating 25.

The polymer coating 25 then preferably extends over the entire axial length of the blade root 7.

Equally, an inner surface 22 of the slot region 13, that is to say the rotor disk 4, can have a polymer coating. This polymer coating can be present in addition to the polymer coating 25 of the blade 6, or as an alternative thereto. It then also preferably extends over the entire axial length of the slot region 13.

This coating is preferably based on one or more fluoropolymers, e.g. polytetrafluoroethylene (PTFE), perfluoroalkoxy (PFA), perfluoroethylenepropylene (FEP).

Furthermore, it is also preferable for one or more solid lubricants, which are embedded in the matrix of the polymer coating 25 of the blade 6 or of the slot region 13, to be present.

In the pressure face region 24 of rotor blades 6, these coating systems can reduce the input of energy due to relative movement between the rotor blade and rotor disk slot components, and reduce or prevent possible fretting and thus also fretting fatigue.

They also prevent, by virtue of different material classes (coating: polymer, rotor disk: metal, for example steel) and the solid lubricants optionally embedded in the polymer coating, adhesion/cold welding in the pressure face region of the blade root and the rotor disk slot. This ensures simple installation/removal of the rotor blades 6. A long-term separating effect is ensured in contrast to the lubricants used in the context of installation/removal. Furthermore, repair/reconditioning of operationally stressed blades 6 having a coating in the root region 7 is possible on-site with no greater additional effort.

The limiting factor for the proposed polymer-based coating 25 is the operational temperature. In the case of compressors, depending on the compressor characteristic variables, this might permit use only in forward compressor stages, and, in the case of turbines, depending on the turbine characteristic variables, use only in rear turbine stages. Future developments might broaden the field of application by raising the operational temperature.

The inventive step lies in the use of polymer-based coating systems in the region of the compressor rotor blades 6 in order to reduce or prevent fretting and fretting fatigue, and also to prevent adhesion/cold welding over the entire service life and thus to prevent consequent secondary damage during removal. In contrast to the current state of the art, a long-term separating effect between the rotor blade 6 and the rotor disk slot 13 in the pressure face region 24 is made possible, and the load-bearing behavior is improved.

The described embodiments has the following advantages over the rotor blade coating used hitherto in the root region 7, or over compressor rotor blades 6 which are uncoated in the region of the blade root 7 or the pressure face region 24:
a long-term separating effect between the blades 6 and rotor disk 4 components in the slot region 13 and thus prevention of adhesion/cold welding (during installation, operation and removal) and fretting and fretting fatigue in the pressure face region (during operation);
installation/removal is simplified by the coating;
more evenly distributed compressive stress in the pressure face region 24, i.e. reduction in localized stress concentrations, as a consequence of the polymer-based coating having a lower Young's modulus than the base material (steel);
more cost-effective coating material 25 in comparison to CuNiIn and similar coating systems
more cost-effective application method, e.g. using an airbrush, in comparison to plasma flame spraying for e.g. CuNiIn and similar coating systems;
reconditioning of operationally stressed blades 6 is possible on-site with no additional effort
improved damping behavior (depending on the thickness of the coating);
additional passive corrosion protection for the rotor blade 6 when coated; and
possibly the option of dispensing with additional lubricant during assembly.

FIG. 2 is a three-dimensional illustration of a turbine blade 6 or compressor blade 6. Since, as described above, the pressure face region 24 is particularly subject to damage, in particular only this region is coated with a polymer 25. The polymer coating 25 preferably extends over the entire axial length of the pressure face region 24 and can also encompass the entire root region 20, 23, 24, 26.

The polymer coating 25 for the blade root 7 or the slot region 13 can be fluoropolymer-based and also, in particular, contain one or more solid lubricants.

Although the invention has been illustrated and described in greater detail with reference to the preferred exemplary embodiment, the invention is not limited to the examples disclosed, and further variations can be inferred by a person skilled in the art, without departing from the scope of protection of the invention.

For the sake of clarity, it is to be understood that the use of “a” or “an” throughout this application does not exclude a plurality, and “comprising” does not exclude other steps or elements.

1-11. (canceled)

12. A gas turbine blade or compressor blade which has, on the blade root, two pressure face regions, wherein only both pressure face regions have, entirely, a polymer coating.

13. The blade as claimed in claim 12, in which the polymer coating is present on the entire blade root region and not on an end face of the blade root.

14. The blade as claimed in claim 12, in which the polymer coating extends over the entire axial length of the pressure face region or of the blade root region.

15. A rotor having a rotor disk and a turbine blade or compressor blade, wherein the rotor has a polymer coating in the slot region of the rotor disk or of the turbine blade or compressor blade.

16. The rotor as claimed in claim 15, which has a turbine blade or compressor blade.

17. The rotor as claimed in claim 15, in which a polymer coating is present on the slot region of the rotor disk.

18. The rotor as claimed in claim 15, in which a polymer coating is present only in the slot region and only on the rotor disk.

19. The blade or rotor as claimed in claim 12, in which the polymer is a fluoropolymer.

20. The blade or rotor as claimed in claim 12, in which the polymer coating on the blade or in the slot region contains one or more solid lubricants.

21. The rotor as claimed in claim 15, in which the polymer coating extends over the entire axial length of the slot region.
